(19) United States
(12) Patent Application Publication
(10) Pub. No.: US 2006/0078184 A1
(43) Pub. Date: Apr. 13, 2006

(54) Intelligent splitting of volume data

(76) Inventors: Hong Shen, Princeton, NJ (US); Ernst Bartsch, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/130,466

(22) Filed: May 16, 2005

Related U.S. Application Data
(60) Provisional application No. 60/618,007, filed on Oct. 12, 2004.

(51) Int. Cl. G06K 9/00

(52) U.S. Cl. 382/131; 358/450

(57) ABSTRACT

A system and method for intelligent splitting of volume data are provided, including an adapter for receiving group order scan data or whole body scan data, a feature detector in signal communication with the adapter for detecting global features in the received scan data and for defining separation lines relative to the detected features along an axis of the scan data, and a data splitter in signal communication with the adapter for splitting the scan data into data sets in accordance with the defined separation lines.

### CROSS-REFERENCE TO RELATED APPLICATION

This application claims the benefit of U.S. Provisional Application Ser. No. 60/618,007 (Attorney Docket No. 2004P17402US), filed Oct. 12, 2004 and entitled “Intelligent Data Splitting for Volume Data”, which is incorporated herein by reference in its entirety.

### BACKGROUND

With the increased development of hardware technologies for medical imaging equipment, large portions of the human body and even the whole body can now be scanned in a single study. This, in turn, raises the need for automatic extraction of image sections from large volumes of data.

An exemplary scenario is a group order issued by a physician. A patient might need to have examinations of chest, abdomen, and pelvis, for example. The radiologist receives orders from multiple specialists, and groups these three studies together to form a group order to scan the patient's upper body. This group order, instead of separate orders, improves efficiency and utility of the equipment.

Afterwards, this data needs to be split into three data sections including the chest, the abdomen, and pelvis, respectively, allowing limited overlaps between the adjacent sections. In this way, each of the specialists only receives the pertinent data section of interest, thus avoiding the wasted bandwidth for both transmission and storage of unneeded data. Typically, this is done manually, which is a tedious and time-consuming job.

In another scenario, a general study for screening of various diseases may cover the complete human body. This may become more popular with increased needs for health maintenance and disease prevention. In this scenario, the effective data splitting for a whole body scan becomes even more important, since the data is so large that it is prohibitive to send it to each specialist regardless of his or her interests.

Thus, what is needed is a system for intelligent splitting of volume data to automatically extract any data section that contains the desired organs or body regions from group order data or whole-body volume data, where the user can require that the image section to be extracted include either such body regions as head, neck, abdomen, leg, and the like, or such internal organs as brain, heart, lung, liver, kidney, and the like.

### SUMMARY

These and other drawbacks and disadvantages of the prior art are addressed by an apparatus and method for intelligent splitting of volume data.

An exemplary system for intelligent splitting of volume data includes an adapter for receiving group order scan data or whole body scan data, a feature detector in signal communication with the adapter for detecting global features in the received scan data and for defining separation lines relative to the detected features along an axis of the scan data, and a data splitter in signal communication with the adapter for splitting the scan data into data sets in accordance with the defined separation lines.

A corresponding method for intelligent splitting of volume data includes receiving at least one of group order scan data and whole body scan data, detecting global features in the received scan data, defining separation lines relative to the detected features along an axis of the scan data, and splitting the scan data into a plurality of data sets in accordance with the defined separation lines.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a system and method for intelligent splitting of volume data in accordance with the following exemplary figures, in which:

FIG. 1 shows a schematic diagram of a system for intelligent splitting of volume data in accordance with an illustrative embodiment of the present disclosure;

FIG. 2 shows a flow diagram of a method for intelligent splitting of volume data in accordance with an illustrative embodiment of the present disclosure;

FIG. 3 shows graphical diagrams of axial profiles for intelligent splitting of volume data in accordance with an illustrative embodiment of the present disclosure; and

FIG. 4 shows graphical diagrams of axial and coronal views for intelligent splitting of volume data in accordance with an illustrative embodiment of the present disclosure.

### DETAILED DESCRIPTION OF PREFERRED EMBODIMENTS

An exemplary embodiment of the present disclosure automatically extracts data for body sections of interest from volume data sets obtained from major medical modalities. This facilitates savings of storage and transmission bandwidth, and improves data sharing efficiencies.

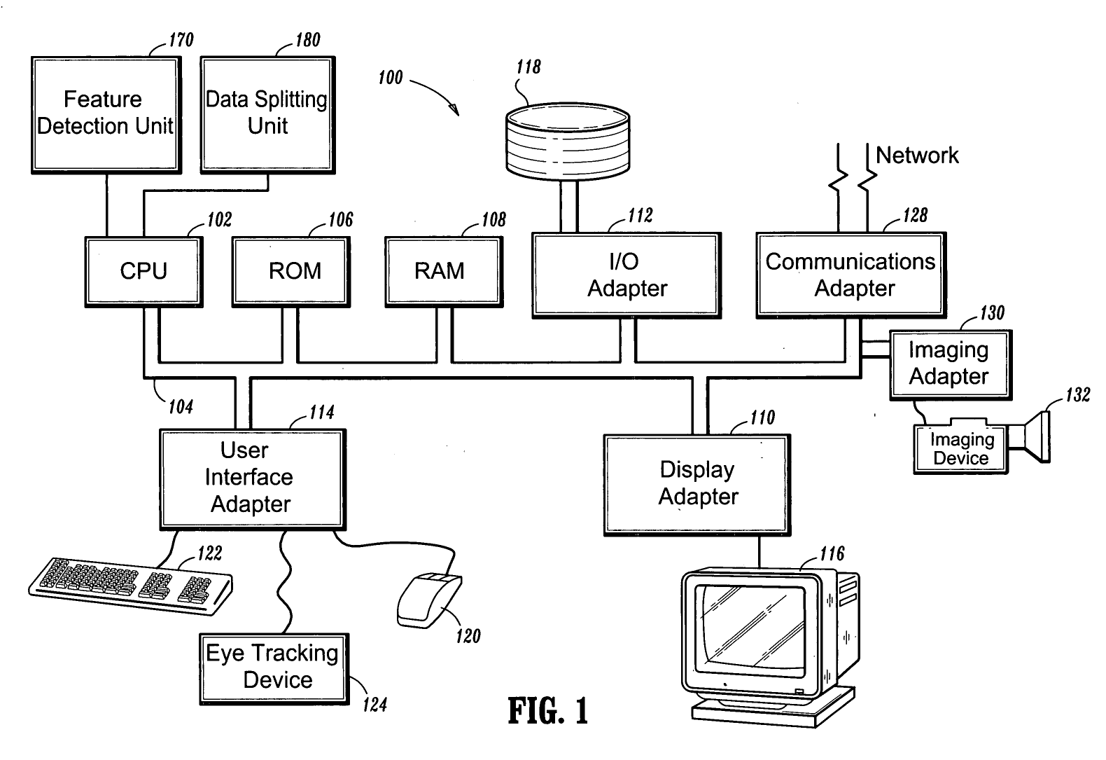

As shown in FIG. 1, a system for intelligent splitting of volume data, according to an illustrative embodiment of the present disclosure, is indicated generally by the reference numeral 100. The system 100 includes at least one processor or central processing unit (CPU) 102 in signal communication with a system bus 104. A read only memory (ROM) 106, a random access memory (RAM) 108, a display adapter 110, an I/O adapter 112, a user interface adapter 114, a communications adapter 128, and an imaging adapter 130 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, a keyboard 122, and an eye tracking device 124 are in signal communication with the system bus 104 via the user interface adapter 114. An imaging device 132 is in signal communication with the system bus 104 via the imaging adapter 130.

A feature detection unit 170 and a data splitting unit 180 are also included in the system 100 and in signal communication with the CPU 102 and the system bus 104. While the feature detection unit 170 and the data splitting unit 180 are illustrated as coupled to the at least one processor or CPU 102, these components are preferably embodied in computer program code stored in at least one of the memories 106, 108 and 118, wherein the computer program code is executed by the CPU 102.

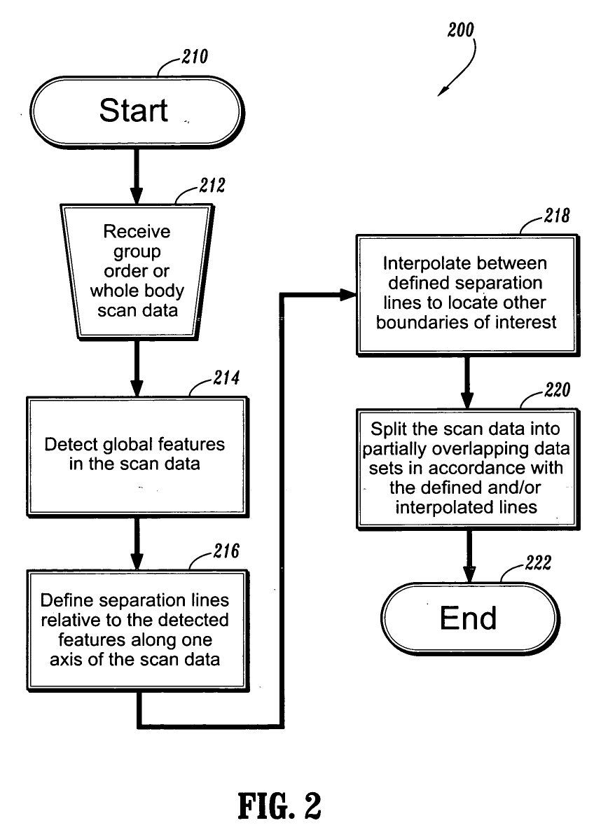

Turning to FIG. 2, a method for intelligent splitting of volume data in accordance with an illustrative embodiment of the present disclosure is indicated generally by the reference numeral 200. The method 200 includes a start block 210 that passes control to an input block 212. The input block 212 receives group order or whole body scan data, and passes control to a function block 214. The function block 214 detects global features in the scan data, and passes control to a function block 216. The function block 216, in turn, defines separation lines relative to the detected features along one axis of the scan data. The function block 216 passes control to a function block 218, which interpolates between defined separation lines to locate other boundaries of interest, and passes control to a function block 220. The function block 220 splits the scan data into partially overlapping data sets in accordance with the defined and/or interpolated lines, and passes control to an end block 222.

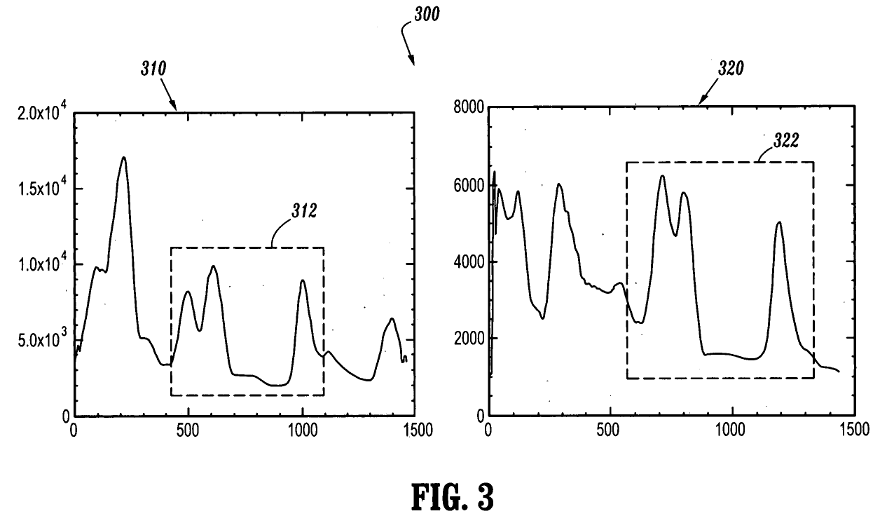

Turning now to FIG. 3, profiles extracted from whole-body scans of patients are indicated generally by the reference numeral 300, including a first profile 310 of a first person and a second profile 320 of a second person. In the profiles 310 and 320, the horizontal axis is the axial slice number, and the vertical axis is the intensity sum of all voxels above a threshold with a given axial slice. Although the profiles differ largely in the global range of intensities as well as shapes, there is a section as indicated by the rectangular boxes 312 and 322 that has similar patterns in both profiles. The peaks and turning points within the section covered by the boxes 312 and 322 represent stable anatomic landmarks of the human body that can be reliably extracted and used as break lines.

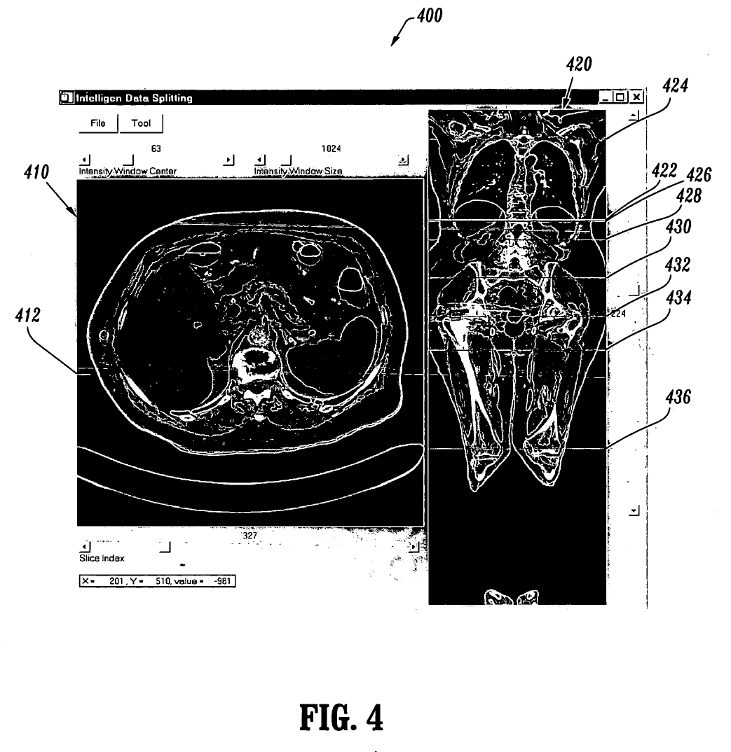

As shown in FIG. 4, orthogonal views of whole body scan data are indicated generally by the reference numeral 400. Here, the views 400 include an axial view 410 and a coronal view 420 of the data for one person. The axial view 410 shows, in the left window, one of about 2000 axial slice images in the whole body scan volume data. The coronal view 420 shows break line detection for data splitting in the right window. A first line 422 in the coronal view 420 indicates the position of the slice shown in the axial view 410, and the two line segments 412 show the position of the coronal view 420 in the axial view 410. The lines 424, 426, 428, 430, 432, 434 and 436 shown in the coronal view 420 are the detected feature landmarks as references for splitting.

In operation of an exemplary embodiment system 100 of FIG. 1 for intelligent splitting of volume data, the data to be split is stored in a series of files where each of the files contains one axial slice image. This is how the DICOM data is stored, for example. Here, the splitting of the volume data is applied in the axial direction. Referring back to FIG. 1, the system 100 includes a feature detection unit 170 that automatically detects lines of separation in the axial direction of the data. After detection, the data splitting unit 180 copies the files that contain the desired section of the slice images to the destination, according to the detected separation lines. Several algorithms are provided to extract the separation lines, where the algorithms may be used alternately or in any combination.

A first algorithm to extract the separation lines is that of feature landmark extraction in the axial direction. Feature points, contours, and regions will be extracted from the volume data and used as landmarks. These landmarks should be robust against the noises and variations. They should be prominent and reliable. There should also be plenty of landmarks that cover the key points in the complete volume data.

A second algorithm to extract the separation lines is that of statistical model construction. Here, approximate models for parts of the human body and organs may be constructed. They will be used for identification of a special body part or an internal organ. Afterwards, model-based segmentation may be used to reliably detect their locations in the volume data.

A third algorithm to extract the separation lines is that of breakpoint interpolation. With detected landmark points, actual break lines will be interpolated with sufficient accuracy. They will then be used to extract a data section from the whole volume data.

A fourth algorithm to extract the separation lines is that of profile analysis using statistical methods. A profile is a 1D array of statistics. The size of the array equals the number of slices in the axial direction. The statistics that can be used include cross-sectional area, sum of intensities within the slice, and the like. By analyzing such a profile, the system is able to identify the break lines of significance. As an example of such a profile, the intensity sum of all high-intensity pixels within each slice may be extracted, such as shown in the profiles 300 of FIG. 3. In this exemplary embodiment, the high-intensity points are defined as those higher than 1200, which are mostly bone pixels. The profiles 310 and 320 of FIG. 3 are two such profiles computed from two whole-body data sets. These two data sets are from two very different human beings, and the profiles are also different. However, there are points on the profile with similar patterns, and these are the points that are stable and general enough to extract as landmarks.

Exemplary system results are shown in FIG. 4. For a 2000 slice whole body volume CT data, the system detected 7 break lines, which represent the most reliable and unique landmarks. For instance, the top 424 and bottom 428 of the lung are two such break lines. In addition, the center of the hip joint 432 and the knee joint 436 are also detected as two unique and stable break lines.

Once the break lines are detected, the system can use interpolation to obtain other lines of interest. For instance, given the top and bottom of the lung, the system can estimate the location and range lines of the chest anatomies, such as heart, airways, and the like.

Due to the size of the large data set, some systems with limited memory may not be able access the volume data completely in system memory. Therefore, special memory management schemes are provided to access only portions of the data at any instant. To effectively and efficiently extract data information, embodiments may include special memory management methods that are a proper fit for the algorithm needs. For example, one exemplary memory management method reads only a portion of the data set at a time. The algorithm extracts the properties such as intensity profiles from that portion of the data, and them removes it from the memory so that another portion of the data can be read into the memory and processed. Such a system may be used on any 3D volume data, such as CT, MR, ultrasound, and the like.

In alternate embodiments of the apparatus 100, some or all of the computer program code may be stored in registers located on the processor chip 102. In addition, various alternate configurations and implementations of the feature detection unit 170 and the data splitting unit 180 may be made, as well as of the other elements of the system 100.

It is to be understood that the teachings of the present disclosure may be implemented in various forms of hardware, software, firmware, special purpose processors, or combinations thereof. Most preferably, the teachings of the present disclosure are implemented as a combination of hardware and software.

Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (CPU), a random access memory (RAM), and input/output (I/O) interfaces.

The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A method for intelligent splitting of volume data, comprising:
receiving at least one of group order scan data and whole body scan data;
detecting global features in the received scan data;
defining separation lines relative to the detected features along an axis of the scan data; and
splitting the scan data into a plurality of data sets in accordance with the defined separation lines.

2. A method as defined in claim 1, further comprising:
interpolating between defined separation lines to locate other boundary lines of interest; and
splitting the scan data into a plurality of data sets in accordance with the interpolated lines.

3. A method as defined in claim 1 wherein the plurality of data sets is partially overlapping.

4. A method as defined in claim 1, detecting global features comprising:
extracting at least one of feature points, contours, and regions from the volume data; and
using at least one of the feature points, contours, and regions as landmarks.

5. A method as defined in claim 4 wherein the landmarks:
are robust against noise and variations;
are prominent and reliable; and
cover the key points in the complete volume data.

6. A method as defined in claim 4, detecting global features further comprising:
interpolating breakpoints between the landmarks; and
extracting a data section from the whole volume data in accordance with the interpolated breakpoints.

7. A method as defined in claim 1, detecting global features comprising:
constructing statistical models of at least one of external regions and internal organs of the human body;
identifying at least one region or organ responsive to the model;
performing model-based segmentation to reliably detect locations of the at least one region or organ in the volume data; and
extracting separation lines of the statistical model construction responsive to the segmentation.

8. A method as defined in claim 1, detecting global features comprising:
profiling a one-dimensional array of statistics, where the size of the array is relative to the number of slices in the axial direction, and the statistics are responsive to at least one of cross-sectional area and the sum of intensities within a slice; and
analyzing the profile to identify break lines of significance.

9. A method as defined in claim 8 wherein the statistics comprise the intensity sum of all high-intensity pixels within each slice, and high-intensity pixels are defined as those higher than a predefined value.

10. A method as defined in claim 9 wherein the predefined value is indicative of bone pixels.

11. A system for intelligent splitting of volume data, comprising:
an adapter unit for receiving at least one of group order scan data and whole body scan data;
a feature detection unit in signal communication with the adapter unit for detecting global features in the received scan data, and for defining separation lines relative to the detected features along an axis of the scan data; and
a data splitting unit in signal communication with the adapter unit for splitting the scan data into a plurality of data sets in accordance with the defined separation lines.

12. A system as defined in claim 11, the feature detection unit comprising interpolation means for interpolating between defined separation lines to locate other boundary lines of interest.

13. A system as defined in claim 11, the feature detection unit comprising:
extraction means for extracting at least one of feature points, contours, and regions from the volume data; and
landmark means for using at least one of the feature points, contours, and regions as landmarks.

14. A system as defined in claim 13, the feature detection unit further comprising:
breakpoint interpolation means for interpolating breakpoints between the landmarks; and
breakpoint extraction means for extracting a data section from the whole volume data in accordance with the interpolated breakpoints.

15. A system as defined in claim 11, the feature detection unit comprising:
modeling means for constructing statistical models of at least one of external regions and internal organs of the human body;
identification means for identifying at least one region or organ responsive to the model;
segmentation means for performing model-based segmentation to reliably detect locations of the at least one region or organ in the volume data; and
separation means for extracting separation lines of the statistical model construction responsive to the segmentation.

16. A system as defined in claim 11, the feature detection unit comprising:
profile means for profiling a one-dimensional array of statistics, where the size of the array is relative to the number of slices in the axial direction, and the statistics are responsive to at least one of cross-sectional area and the sum of intensities within a slice; and
identification means for analyzing the profile to identify break lines of significance.

17. A system as defined in claim 16, the profile means comprising thresholding means for selecting the intensity sum of all high-intensity pixels within each slice, where the high-intensity pixels are defined as those higher than a predefined value.

18. A program storage device readable by machine, tangibly embodying a program of instructions executable by the machine to perform program steps for intelligent splitting of volume data, the program steps comprising:
receiving at least one of group order scan data and whole body scan data;
detecting global features in the received scan data;
defining separation lines relative to the detected features along an axis of the scan data; and
splitting the scan data into a plurality of data sets in accordance with the defined separation lines.

19. A device as defined in claim 18, the program step of detecting global features comprising:
constructing statistical models of at least one of external regions and internal organs of the human body;
identifying at least one region or organ responsive to the model;
performing model-based segmentation to reliably detect locations of the at least one region or organ in the volume data; and
extracting separation lines of the statistical model construction responsive to the segmentation.

20. A device as defined in claim 18, the program step of detecting global features comprising:
profiling a one-dimensional array of statistics, where the size of the array is relative to the number of slices in the axial direction, and the statistics are responsive to at least one of cross-sectional area and the sum of intensities within a slice; and
analyzing the profile to identify break lines of significance.
